(19) United States
(12) Patent Application Publication
(10) Pub. No.: US 2013/0001415 A1
(43) Pub. Date: Jan. 3, 2013

(54) FREQUENCY SCAN LINEAR ION TRAP MASS SPECTROMETRY

(75) Inventors: Chung-Hsuan CHEN, Taipei (TW); I-Chung LU, Taichung City (TW); Ming-Lee CHU, Xizhi City (TW)

(73) Assignee: ACADEMIA SINICA, Taipei (TW)

(21) Appl. No.: 13/534,449

(22) Filed: Jun. 27, 2012

Related U.S. Application Data
(60) Provisional application No. 61/502,140, filed on Jun. 28, 2011.

(51) Int. Cl. H01J 49/36; H01J 49/04; H01J 49/18; H01J 49/16; H01J 49/14

(52) U.S. Cl. 250/283; 250/282; 250/292

(57) ABSTRACT

An ion trap mass spectrometer and methods for obtaining a mass spectrum of ions by scanning an RF frequency applied to the linear ion trap for mass selective ejection of the ions by using two power amplifiers to apply opposite phases of the RF to x and y electrodes.

### CROSS REFERENCE TO RELATED APPLICATIONS

This application claims the benefit of U.S. Provisional Application No. 61/502,140, filed Jun. 28, 2011, which is hereby incorporated by reference in its entirety.

### BACKGROUND OF THE INVENTION

Mass spectrometry is a useful method for identifying a molecule or ion by its mass-to-charge ratio (m/z). Mass spectrometry has been applied to the study of proteins, organelles, and cells to characterize molecular weight, products of protein digestion, proteomic analysis, metabolomics, and peptide sequencing, among other things. A limitation of mass spectrometry is the difficulty in rapidly measuring biomolecules or macromolecules of high mass-to-charge ratio.

Recent progress in mass spectrometry for biomolecules includes electrospray ionization (ESI) and matrix-assisted laser desorption ionization (MALDI). An ESI source can extend the observable mass range by creating ions from large molecules without fragmenting them. However, ESI may produce a number of charge states or multiply-charged ions that often leads to unnecessarily complex mass spectra. Moreover, the signal of a particular biomolecule may be distributed over many peaks in the mass spectrum which reduces the sensitivity of detection. In general, ESI is not suitable for samples having large numbers of compounds. In some cases, a pre-separation device such as HPLC can be used with an ESI source when the sample contains many compounds. For ion trap mass spectrometry, the multiply-charged ions produced by ESI can cause undesirable space-charge effects inside the ion trap. In contrast, MALDI produces singly-charged ions and can reduce or eliminate the disadvantages of ESI. MALDI is convenient for sample preparation and obtaining the entire mass profile of a complex sample.

For proteomics a mass spectrometer should be able to detect a broad mass range. A high linear dynamic voltage range is essential to this goal. Ion trapping methods such as two-dimensional linear ion traps (LIT) have been useful for proteomics in general by mass-selective ejection of ions from the trap. An advantage of the linear ion trap is that it has a large capacity for ions. This advantage may reduce the space charge effect during mass spectral analysis. However, the mass-to-charge ratio detected by voltage scanning linear ion trap mass spectrometry is limited to about 6000, which is below the mass for most proteins.

There is a continuing need for methods for detecting proteins and biomolecules using a mass spectrometer. There is also a need for an apparatus and arrangement for a mass spectrometer that can detect biomolecular ions over a wide mass range. There is a further need for a mass spectrometer apparatus and methods capable of detecting biomolecules rapidly at high resolution for studies in proteomics.

### BRIEF SUMMARY OF THE INVENTION

This invention relates to the fields of mass spectrometry and proteomic and biomolecule research. In particular, this application relates to methods for high speed proteomics and detecting large biomolecular ions in mass spectrometry. More particularly, this application relates to linear ion trap devices and frequency scan methods for mass spectrometry for detecting macromolecules and biomolecules.

Embodiments of this invention can provide methods for detecting proteins and biomolecules using a mass spectrometer. This disclosure also provides an apparatus and arrangement for a mass spectrometer that can detect large biomolecular ions. Embodiments of this disclosure may further provide a mass spectrometer apparatus and methods capable of detecting biomolecules rapidly at high resolution for studies in proteomics.

This invention provides novel ion trapping, ejection and detection methods for mass spectrometry using a two-dimensional linear ion trap that are useful for proteomics studies. In this invention, frequency-scanning linear ion trap mass spectrometry is demonstrated with matrix-assisted desorption/ionization (MALDI) that can be used to measure very high mass-to-charge ratio (m/z) ions. A MALDI-LIT mass spectrometer of this invention can analyze mass to charge ratios of up to 150,000 and greater.

In some aspects, this disclosure provides methods for obtaining a mass spectrum of ions comprising providing a two dimensional linear ion trap comprising x and y electrodes, scanning an RF frequency applied to the linear ion trap for mass selective ejection of the ions by using two power amplifiers to apply opposite phases of the RF to the x and y electrodes. The x and y electrodes can be two x electrode rods and two y electrode rods in a quadrupole arrangement. Each power amplifier may be tuned with a capacitance to provide the same amplitude of RF and a fixed degree of phase difference of the RF to the x and y electrodes.

In some embodiments, the mass selective ejection of the ions is generated by mass selective instability with or without resonance excitation by boundary ejection. The ejection of the ions can be axial along the z axis, or perpendicular through a slot in an x electrode. The ejection of the ions may be through a slot in an x electrode.

In certain aspects, the linear ion trap may contain a buffer gas of helium, or other rare gas or mixture of gases, at a pressure of from 1 to 500 mTorr.

The ions can be generated by MALDI, electrospray ionization, laser ionization, thermospray ionization, thermal ionization, electron ionization, chemical ionization, inductively coupled plasma ionization, glow discharge ionization, field desorption ionization, fast atom bombardment ionization, spark ionization, or ion attachment ionization.

In further embodiments, this invention provides methods for obtaining a mass spectrum of ions comprising trapping the ions in a linear ion trap comprising two x electrode rods and two y electrode rods in a quadrupole arrangement, and two end-cap electrodes, providing a scanning frequency of RF, and amplifying the scanning frequency of RF using two power amplifiers to apply opposite phases of the RF to the x and y electrodes with the same RF amplitude.

In some aspects, this disclosure includes a linear ion trap mass spectrometer for obtaining a mass spectrum of ions, the linear ion trap mass spectrometer comprising a two dimensional linear ion trap for trapping and ejecting the ions comprising two slotted x electrode rods and two y electrode rods in a quadrupole arrangement, an inductance forming an LC circuit with the capacitance of the ion trap, a first end cap plate perpendicular to the electrode rods at a first end of the linear ion trap and a second end cap plate perpendicular to the electrode rods at a second end of the linear ion trap, wherein the first end cap defines an opening for a sample probe, and wherein the second end cap defines an opening for a laser beam, a plastic cover isolating the linear ion trap so that the atmosphere in the trap can be controlled with a pump, a controller for providing a scanning ion ejecting RF frequency, a dynode, and a charge detector.

In certain embodiments, the electrode rods may be 54 mm long and 9 mm in diameter. The slots in the x electrode rods may be 0.4 mm in width and 34 mm in length. The half distance between the x electrode rods can be 9.25 mm. The half distance between the y electrode rods can be 8.5 mm. The end plates can be spaced apart by 1 to 10 mm from the ends of the electrode rods.

In certain aspects, the linear ion trap may contain a buffer gas. The buffer gas can be helium, or other rare gas or mixture of gases, at a pressure of from 1 to 500 mTorr.

In the following description, reference is made to the accompanying drawings that form a part hereof, and in which is shown by way of illustration specific embodiments which may be practiced. These embodiments are described in detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

### BRIEF DESCRIPTION OF THE DRAWINGS

FIG. 1 shows an embodiment of a linear ion trap for frequency scan mass spectrometry.

FIG. 2 shows a diagram of a frequency-scanning process with a linear ion trap using two high voltage MOSFET operational amplifiers. The output voltages of the power amplifiers can reach ±450 V. The power amplifiers produce stable amplitude of RF in the region below 300 kHz.

FIG. 3 shows a frequency scan MALDI-LIT mass spectrum of Cytochrome C, MW 12,360.

FIG. 4 shows a frequency scan MALDI-LIT mass spectrum of BSA, MW 66,000.

FIG. 5 shows a frequency scan MALDI-LIT mass spectrum of IgG, a 150 kDa protein.

### DETAILED DESCRIPTION OF THE INVENTION

Embodiments of this invention provide novel methods in mass spectrometry for the study of proteins, organelles, and cells to characterize molecular weight, products of protein digestion, proteomic analysis, metabolomics, and peptide sequencing, among other things.

This disclosure provides novel ion trapping, ejection and detection methods for mass spectrometry using a two-dimensional linear ion trap that are useful for proteomics studies.

In this invention, frequency-scanning linear ion trap mass spectrometry is demonstrated with matrix-assisted desorption/ionization (MALDI) that can be used to measure very high mass-to-charge ratio (m/z) ions. A MALDI-LIT mass spectrometer of this invention can analyze mass to charge ratios of up to 150,000 and greater.

In brief, mass-selective ejection of ions from the trap can be done by frequency-scanning a resonant RLC circuit of the mass spectrometer in which the ion trap is a capacitance. The frequency sweep can be made to correspond to a range of mass to charge ratios for the detected ions.

In this invention, the mass spectra of large biomolecular ions produced by MALDI are obtained by frequency scanning methods using a linear ion trap as a mass analyzer. The methods and devices of this disclosure can extend the mass-to-charge ratio detection limit to 150,000 and greater.

The maximum range of mass-to-charge ratio in a linear ion trap can be estimated by the following equation:

$$\frac{m}{z} = \frac{4 {V}_{0 \to p} e}{{q}_{x} {r}_{0}^{2} {ω}^{2}} \qquad Equation 1$$

where V_{0->p} is the zero-to-peak amplitude of the RF potential, r₀ is the radius of the inscribed circle to the rod array, ω is the radial frequency of the RF potential, and qₓ is the trapping parameter.

In conventional ion trap mass spectrometry, the amplitude of RF is scanned for mass analysis. The RF frequency is usually fixed at about 1 MHz and generated by a resonance RLC electronic circuit. The maximum mass-to-charge ratio achieved is typically less than 6000 depending on the radius of the ion trap and the highest voltage the electronic circuit can withstand. To increase the mass-to-charge ratio following Equation 1, the resonance frequency can be reduced by increasing the capacitance and inductance of the RLC circuit. Nevertheless, the voltage capability of the circuit is a limitation. Moreover, the range of mass-to-charge ratio is still limited at a single fixed RF frequency if the voltage scan detection process is employed.

This disclosure provides methods and devices to measure a broad range of mass-to-charge ratios, as well as very high mass-to-charge ratios by frequency-scanning mass spectrometry.

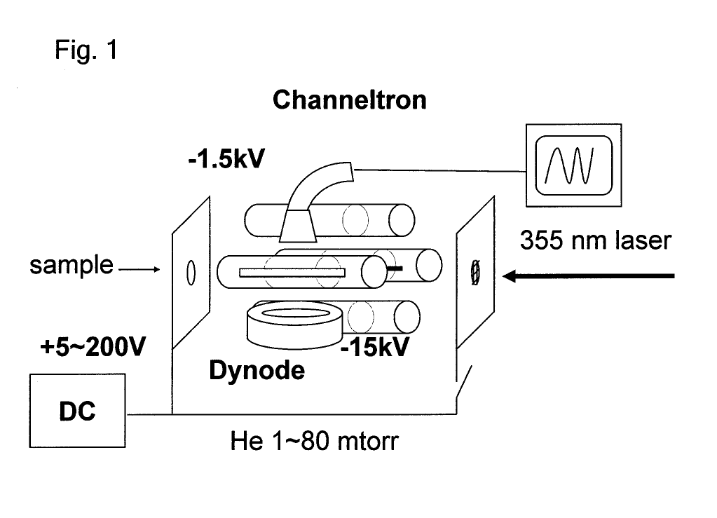

As shown in FIG. 1, in certain embodiments, a linear ion trap is employed having x and y rods that were machined as cylindrical structures in stainless steel. Each rod is designed as 54 mm long and 9 mm diameter. Two pairs of electrodes and two planes of endcaps, 50 mm×50 mm, were used to construct the linear ion trap. Along the center section of the x electrode rods, a slot of 0.4 mm width and 34 mm length is cut for ion ejection. Two distinct distances between electrodes are designed in order to compensate destructive field effect from presence of slots. The half-distance between x pair of electrode (rₓ₀) is 9.25 mm, and the half-distance between y pair of electrode (r_{y0}) is 8.5 mm. To confine ions in the z axis direction, which is parallel to the elongated x and y electrodes, the endcaps are placed 1˜10 mm from the end of electrodes. There is a 5 mm diameter hole placed in the center of the endcap plate. One of the holes, backward, is the inlet of sample probe, and another one is provided for passage of a laser beam. All components are mounted on a set of ceramic base.

The ejection of the ions can be axial along the z axis, or perpendicular through a slot in an x electrode.

In operation, the laser beam is focused on the sample-probe tip via the opposite endcap using an optical system. MALDI ions are generated inside the ion trap and are picked up by the RF field in the trapping process. To catch heavy ions in an ion trap, a high pressure of a buffer gas is used. More than 20 mTorr of helium leaks directly into the trap continuously to reduce kinetic energy of the MALDI generated ions. The trap is isolated by a plastic cover with a slit on the detector side, so that the vacuum of the main chamber can be maintained around 5×10⁻⁵ Torr by a Varian turbo pump, for example, TURBO-V701 NAVIGATOR PUMP. After several laser shots, trapped ions are ejected by scanning the RF frequency downward linearly. Mass spectra are then generated by mass selective instability without resonance excitation by boundary ejection. The detection system consists of a conversion dynode held at −15 kV and a channeltron electron multiplier, for example DeTech XP-2217. After frequency scanning, ejected ions pass through the slit on the x electrode to the detector, and the detection system is arranged on only a single side of the linear ion trap. The output current is recorded by a digital storage oscilloscope, for example LeCory WaveRunner 64Xi, without any pre-amplification.

In the frequency scanning methods disclosed herein, two oppositely phased RFs are required to be applied to the x and y rods of the (2D) linear ion trap, respectively. The differences between the amplitudes and the phases of the two oppositely phased RFs applied to the x and y rods should be minimized and maintained stable to balance the 2D trap.

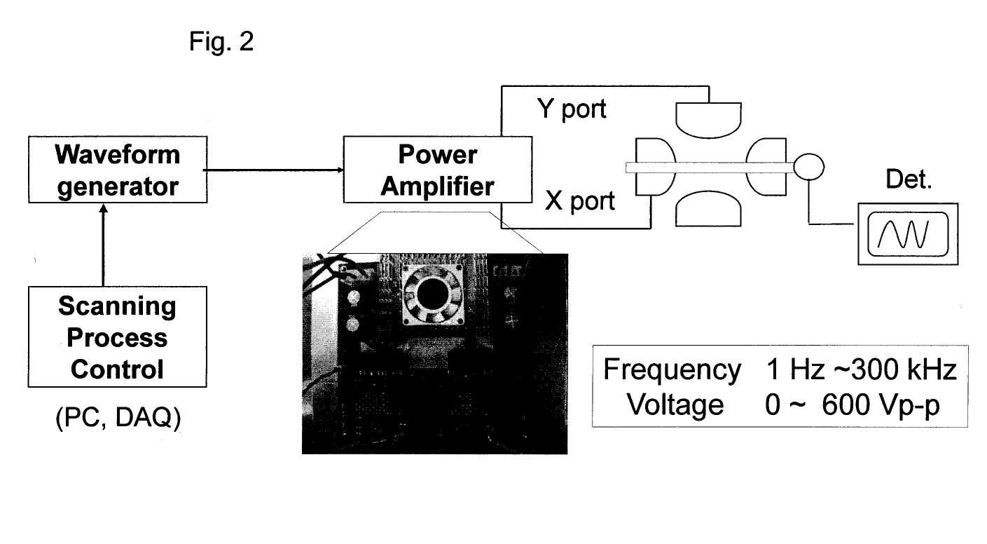

As shown in FIG. 2, in some embodiments of this invention, a frequency-scanning process can be performed on a linear ion trap by using two high voltage MOSFET operational amplifiers, for example APEX MICROTECHNOLOGY model PA94, are used as sine-wave power amplifiers. In order to balance or match the output voltage of the two amplifiers, two small capacitances are attached to the circuit for fine tuning. The output voltages of the power amplifiers can reach±450 V. The power amplifiers are driven by two DC power supplies, for example Matsusada Precision Inc. Model S30-0.6N and S30-0.6P, which produce stable amplitude of RF in the region below 300 kHz. The DC power supplies are controlled by a PC and a DAQ converter, for example NI-USB-6221.

### Example 1

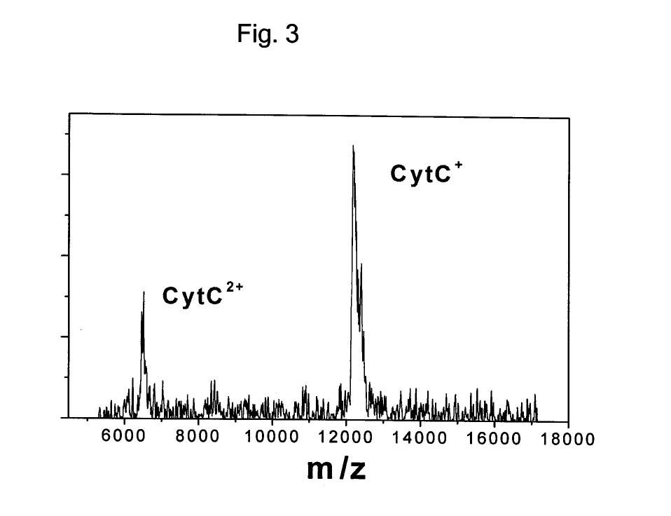

The frequency scan MALDI-LIT mass spectrum of Cytochrome C, MW 12,360, is shown in FIG. 3. An RF of 170 kHz was employed as the trapping frequency at 650 Vₚ₋ₚ. After that, the frequency scanning process was carried out from 170 kHz to 70 kHz during 100 ms. The mass spectrum was collected with an oscilloscope. As shown in FIG. 3, the spectrum contained two distinctive peaks. The feature at m/z of about 12,360 was assigned to a singly charged Cytochrome C ion, and the feature at m/z of about 6,180 was assigned to a doubly charged Cytochrome C ion.

### Example 2

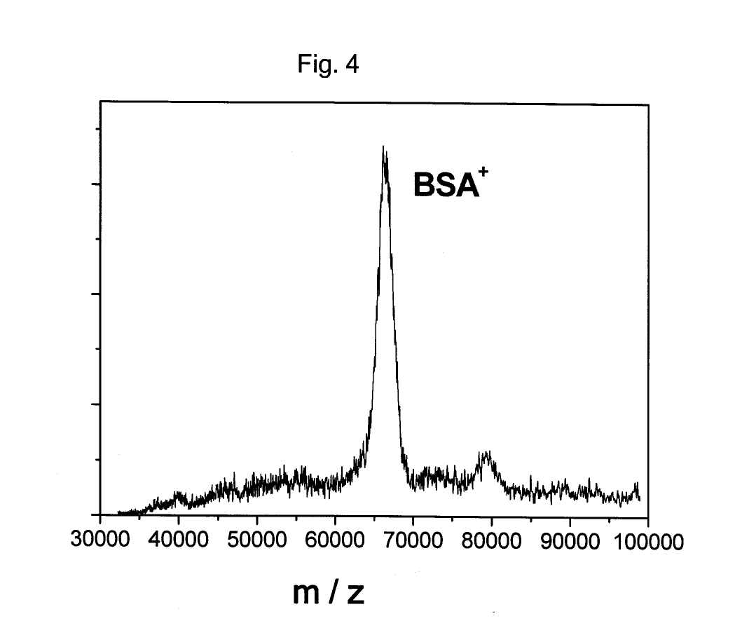

The frequency scan MALDI-LIT mass spectrum of BSA, MW 66,000, is shown in FIG. 4. The trapping frequency was 70 kHz, and the stationary amplitude of RF was 650 volt. The frequency scanning process was carried out from 70 kHz to 40 kHz through 100 ms sweeping time.

### Example 3

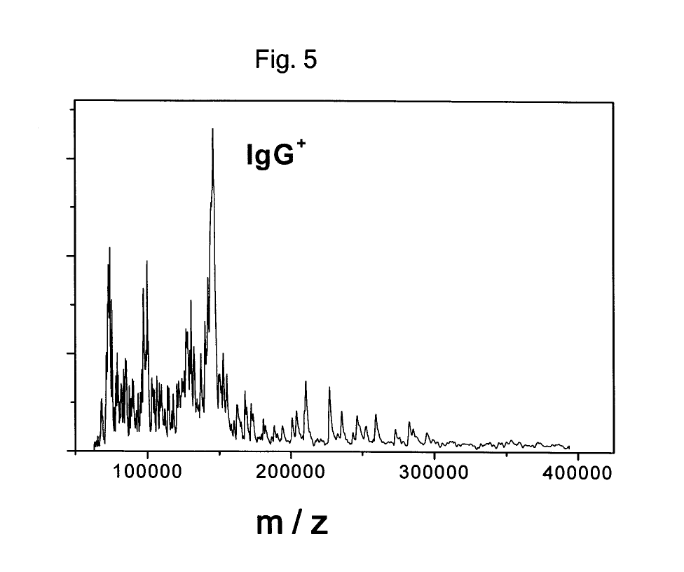

The frequency scan MALDI-LIT mass spectrum of IgG, a 150 kDa protein, is shown in FIG. 5. This mass spectrum was collected by scanning the RF from 80 kHz to 20 kHz. During the 100 ms sweeping time, the stationary amplitude of RF was also 650 volt. This frequency scan MALDI-LIT mass spectrum demonstrated that the methods of this invention can be used to extend the range of observed mass-to-charge ratios to values as much as twenty-five times greater than without the frequency scanning methods.

A frequency scan method can be used for a linear ion trap. For tuning a specific resonant frequency, the ion trap may be coupled with a variable capacitor. The capacitance of the variable capacitor can be controlled to vary the resonance frequency of the RLC circuit. When the value of the inductor is fixed, the capacitance of the variable capacitor can be used to obtain a specific resonant frequency in a stepwise scan.

In additional aspects, this invention may provide a mass spectrometer apparatus and methods capable of detecting biomolecules such as proteins, antibodies, protein complexes, protein conjugates, nucleic acids, oligonucleotides, DNA, RNA, polysaccharides and many others with high detection efficiency and resolution.

In some embodiments, the methods of this invention may be used to obtain the mass spectra of nanoparticles, viruses, and other biological components and organelles having sizes in the range of up to about 50 nanometers or greater.

In some variations, the apparatus and methods of this disclosure can also provide mass spectra of small molecule ions.

Examples of methods for ionization in mass spectrometry include laser ionization, MALDI, electrospray ionization, thermospray ionization, thermal ionization, electron ionization, chemical ionization, inductively coupled plasma ionization, glow discharge ionization, field desorption ionization, fast atom bombardment ionization, spark ionization, or ion attachment ionization.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described herein.

All publications and patents and literature specifically mentioned herein are incorporated by reference for all purposes. Nothing herein is to be construed as an admission that the invention is not entitled to antedate such disclosure by virtue of prior invention.

It is understood that this invention is not limited to the particular methodology, protocols, materials, and reagents described, as these may vary. It is also to be understood that the terminology used herein is for the purpose of describing particular embodiments only, and is not intended to limit the scope of the present invention which will be encompassed by the appended claims.

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprises,” “comprising”, “containing,” “including”, and “having” can be used interchangeably.

Without further elaboration, it is believed that one skilled in the art can, based on the above description, utilize the present invention to its fullest extent. The following specific embodiments are, therefore, to be construed as merely illustrative, and not limitative of the remainder of the disclosure in any way whatsoever.

All of the features disclosed in this specification may be combined in any combination. Each feature disclosed in this specification may be replaced by an alternative feature serving the same, equivalent, or similar purpose.

What is claimed is:

1. A method for obtaining a mass spectrum of ions comprising:
providing a two dimensional linear ion trap comprising x and y electrodes;
scanning an RF frequency applied to the linear ion trap for mass selective ejection of the ions by using two power amplifiers to apply opposite phases of the RF to the x and y electrodes.

2. The method of claim 1, wherein the x and y electrodes are two x electrode rods and two y electrode rods in a quadrupole arrangement.

3. The method of claim 1, wherein each power amplifier is tuned with a capacitance to provide the same amplitude of RF and a fixed degree of phase difference of the RF to the x and y electrodes.

4. The method of claim 1, wherein the mass selective ejection of the ions is generated by mass selective instability with or without resonance excitation by boundary ejection.

5. The method of claim 1, wherein the ejection of the ions is axial or perpendicular.

6. The method of claim 1, wherein the ejection of the ions is through a slot in an x electrode.

7. The method of claim 1, wherein a fixed voltage of from +5 to +200 V is applied to the end plates.

8. The method of claim 1, wherein the linear ion trap contains a buffer gas of helium or other rare gas at a pressure of from 1 to 500 mTorr.

9. The method of claim 1, wherein the ions are generated by MALDI, electrospray ionization, laser ionization, thermospray ionization, thermal ionization, electron ionization, chemical ionization, inductively coupled plasma ionization, glow discharge ionization, field desorption ionization, fast atom bombardment ionization, spark ionization, or ion attachment ionization.

10. A method for obtaining a mass spectrum of ions comprising:
trapping the ions in a linear ion trap comprising two x electrode rods and two y electrode rods in a quadrupole arrangement, and two end-cap electrodes;
providing a scanning frequency of RF; and
amplifying the scanning frequency of RF using two power amplifiers to apply opposite phases of the RF to the x and y electrodes with the same RF amplitude.

11. The method of claim 10, wherein each power amplifier is tuned with a capacitance to provide the same amplitude of RF and a fixed degree of phase difference of the RF to the x and y electrodes.

12. The method of claim 10, further comprising mass selective ejection of the ions generated by mass selective instability with or without resonance excitation by boundary ejection.

13. The method of claim 12, wherein the ejection of the ions is axial or perpendicular.

14. The method of claim 12, wherein the ejection of the ions is through a slot in an x electrode.

15. The method of claim 10, wherein a fixed voltage of from +5 to +200 V is applied to the end plates.

16. The method of claim 10, wherein the linear ion trap contains a buffer gas of helium or other rare gas at a pressure of from 1 to 500 mTorr.

17. The method of claim 10, wherein the ions are generated by MALDI, electrospray ionization, laser ionization, thermospray ionization, thermal ionization, electron ionization, chemical ionization, inductively coupled plasma ionization, glow discharge ionization, field desorption ionization, fast atom bombardment ionization, spark ionization, or ion attachment ionization.

18. A linear ion trap mass spectrometer for obtaining a mass spectrum of ions, the linear ion trap mass spectrometer comprising:
a two dimensional linear ion trap for trapping and ejecting the ions comprising two slotted x electrode rods and two y electrode rods in a quadrupole arrangement;
an inductance forming an LC circuit with the capacitance of the ion trap;
a first end cap plate perpendicular to the electrode rods at a first end of the linear ion trap and a second end cap plate perpendicular to the electrode rods at a second end of the linear ion trap, wherein the first end cap defines an opening for a sample probe, and wherein the second end cap defines an opening for a laser beam;
a plastic cover isolating the linear ion trap so that the atmosphere in the trap can be controlled with a pump;
a controller for providing a scanning ion ejecting RF frequency;
a dynode; and
a charge detector.

19. The linear ion trap mass spectrometer of claim 18, wherein the electrode rods are 54 mm long and 9 mm in diameter.

20. The linear ion trap mass spectrometer of claim 18, wherein the end plates are spaced apart by 1 to 10 mm from the ends of the electrode rods.

21. The linear ion trap mass spectrometer of claim 18, further comprising a buffer gas within the linear ion trap.

22. The linear ion trap mass spectrometer of claim 21, wherein the buffer gas is helium or other rare gas at a pressure of from 1 to 500 mTorr.

23. The ion trap mass spectrometer of claim 18, wherein the ions are generated by MALDI, electrospray ionization, laser ionization, thermospray ionization, thermal ionization, electron ionization, chemical ionization, inductively coupled plasma ionization, glow discharge ionization, field desorption ionization, fast atom bombardment ionization, spark ionization, or ion attachment ionization.
